(19) United States
(12) Patent Application Publication
(10) Pub. No.: US 2015/0186288 A1
(43) Pub. Date: Jul. 2, 2015

(54) APPARATUS AND METHOD OF OPERATING CACHE MEMORY

(71) Applicant: Samsung Electronics Co., Ltd., Suwon-si (KR)

(72) Inventors: Won-jong LEE, Suwon-si (KR); Young-sam SHIN, Hwaseong-si (KR); Jae-don LEE, Yongin-si (KR)

(73) Assignee: Samsung Electronics Co., Ltd., Suwon-si (KR)

(21) Appl. No.: 14/322,026

(22) Filed: Jul. 2, 2014

(30) Foreign Application Priority Data
Dec. 30, 2013 (KR) 10-2013-0167016

(51) Int. Cl. G06F 12/08; G06T 1/60

(52) U.S. Cl. CPC G06F 12/0891; G06F 12/0822; G06T 1/60; G06T 2200/28

(57) ABSTRACT

Provided are an apparatus and method of operating a cache memory. The cache memory apparatus includes a cache memory configured to store node data of an acceleration structure as cache data and to store hit frequency data corresponding to the cache data, and a controller configured to determine whether node data corresponding to a request is stored in the cache memory, and to update any one of the cache data based on the hit frequency data.

### RELATED APPLICATIONS

This application claims the benefit under 35 USC 119(a) of Korean Patent Application No. 10-2013-0167016, filed on Dec. 30, 2013, in the Korean Intellectual Property Office, the entire disclosure of which is incorporated herein by reference for all purposes.

### BACKGROUND

1. Field

The following description relates to cache memory systems for ray tracing and methods of operating the same.

2. Description of Related Art

Three-dimensional (3D) rendering refers to image processing that synthesizes 3D object data into an image that is shown at a given viewpoint of a camera. Examples of a rendering method include a rasterization method that generates an image by projecting a 3D object onto a screen, and a ray tracing method that generates an image by tracing the path of light that is incident along a ray traveling toward each image pixel at a camera viewpoint.

The ray tracing method may generate a high-quality image because it more accurately portrays the physical properties (reflection, refraction, and penetration, etc.) of light in a rendering result. However, the ray tracing method has difficulty in high-speed rendering because it requires a relatively large number of calculations. In terms of ray tracing performance, factors causing a large number of calculations are generation and traversal (TRV) of an acceleration structure (AS) in which scene objects to be rendered are spatially separated, and an intersection test (IST) between a ray and a primitive.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, there is provided a cache memory apparatus including a cache memory configured to store node data of an acceleration structure as cache data and to store hit frequency data corresponding to the cache data, and a controller configured to determine whether node data corresponding to a request is stored in the cache memory, and to update any one of the cache data based on the hit frequency data.

The hit frequency data may be determined based on an access reservation frequency to a relevant node.

The node data may be information about a node for traversing the acceleration structure in ray tracing.

The cache memory may comprise a plurality of data sets, and each of which comprises the cache data, the hit frequency data, and tag data.

The controller may be further configured to receive a set address and a tag address of the requested node data, and to compare the tag data denoted by the set address with the tag address to determine whether the requested node data is stored.

The controller may be further configured to determine that a cache hit occurs and to output the corresponding cache data, in response to the determination that the tag address matches any one of the tag data.

The controller may be further configured to delete the cache data corresponding to a hit frequency data having a smallest value from among the hit frequency data, in response to the tag address not matching any one of the tag data.

The controller may be further configured to determine that a cache miss occurs and to receive new data from a region of an external memory that is indicated by the tag address, in response to the tag address not matching any one of the tag data.

The controller may be further configured to increase a value of the hit frequency data corresponding to the node data in response to a node being pushed into a stack.

The cache memory apparatus may include a victim cache memory configured to store the cache data deleted from the cache memory.

The controller may be further configured to determine that a cache miss occurs and to search whether the node data corresponding to the request is stored in the victim cache memory, in response to the node data corresponding to the request not being stored in the cache memory.

In another general aspect, there is provided a method of managing cache memory, the method including receiving a request for at least one node data of an acceleration structure, determining whether the requested node data is stored in the cache memory, selecting a cache data stored in the cache memory based on hit frequency, and updating the selected cache data.

The hit frequency data may be determined based on an access reservation frequency to a relevant node.

The receiving of the request may include receiving a set address and a tag address of the requested node data, and the determining of whether the requested node data is stored in the cache memory comprises comparing a tag data indicated by the set address with the tag address to determine whether the requested node data is stored, wherein the cache memory comprises a plurality of cache data, hot frequency data, and tag data.

The method may include determining that a cache hit occurs and outputting the cache data corresponding to the matching tag data, in response to any one of the tag data matching the tag address.

The selecting of the cache data may include determining that a cache miss occurs and selecting the cache data corresponding to the hit frequency data having a smallest value from among the hit frequency data indicated by the set address, in response to the tag address not matching any one of the tag data.

The method may include determining that a cache miss occurs and receiving new data from a region of an external memory that is indicated by the tag address, in response to the tag address not matching any one of the tag data.

The method may include increasing a value of the hit frequency data corresponding to the node data in response to a node being pushed into a stack.

The method may include storing the cache data deleted from the cache memory in a victim cache memory.

The method may include determining that a cache miss occurs and searching whether the node data corresponding to the request is stored in the victim cache memory, in response to the node data corresponding to the request not being stored in the cache memory.

Other features and aspects will be apparent from the following detailed description, the drawings, and the claims.

### BRIEF DESCRIPTION OF THE DRAWINGS

FIG. 1 is a diagram illustrating an example of a ray tracing method.

FIG. 2 is a diagram illustrating an example of a ray tracing system.

FIG. 3 is a diagram illustrating an example of an acceleration structure (AS).

FIGS. 4A and 4B are diagrams illustrating examples of a traversal (TRV) method.

FIG. 5 is a diagram illustrating an example of a TRV unit.

FIG. 6 is a diagram illustrating an example of a cache memory system of FIG. 5, according to an embodiment of the present invention;

FIG. 7 is a diagram illustrating an example of a method of operating a cache memory system.

FIG. 8 is a diagram illustrating an example of the operating method of FIG. 7.

FIG. 9 is a diagram illustrating an example of operating a cache memory system.

FIG. 10 is a diagram illustrating an example of the operating method of FIG. 9.

FIG. 11 is a diagram illustrating an example of a method of operating a cache memory system.

FIG. 12 is a diagram illustrating an example of the operating method of FIG. 11.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the systems, apparatuses and/or methods described herein will be apparent to one of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

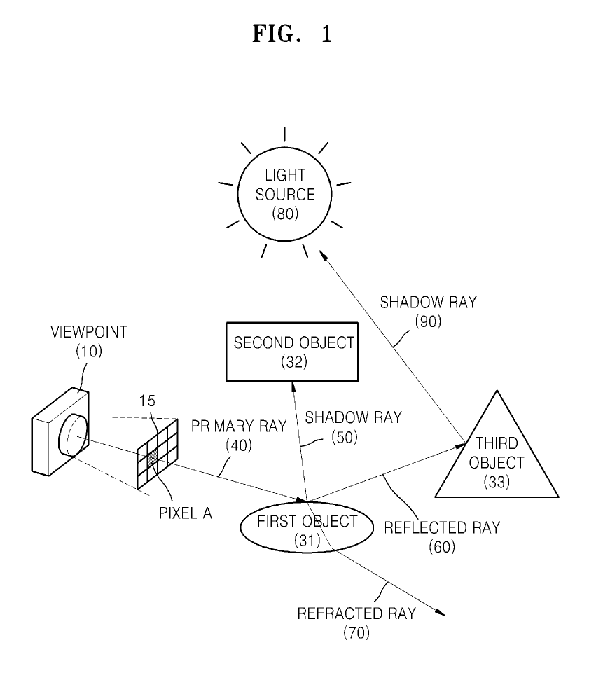

FIG. 1 is a diagram illustrating an example of a ray tracing method.

As illustrated in FIG. 1, three-dimensional (3D) modeling may include a light source 80, a first object 31, a second object 32, and a third object 33. For convenience of description, in FIG. 1, the first object 31, the second object 32, and the third object 33 are represented as 2-dimensional (2D) objects, but the first object 31, the second object 32, and the third object 33 may be 3D objects.

It may be assumed that the reflectivity and refractivity of the first object 31 are greater than 0, and the reflectivity and refractivity of the second object 32 and the third object 33 are 0. The first object 31 reflects and refracts light, and the second object 32 and the third object 33 do not reflect and refract light.

In the 3D modeling illustrated in FIG. 1, a rendering apparatus (e.g., a ray tracing apparatus) may determine a viewpoint 10 for generating a 3D image and determine a screen 15 according to the determined viewpoint 10.

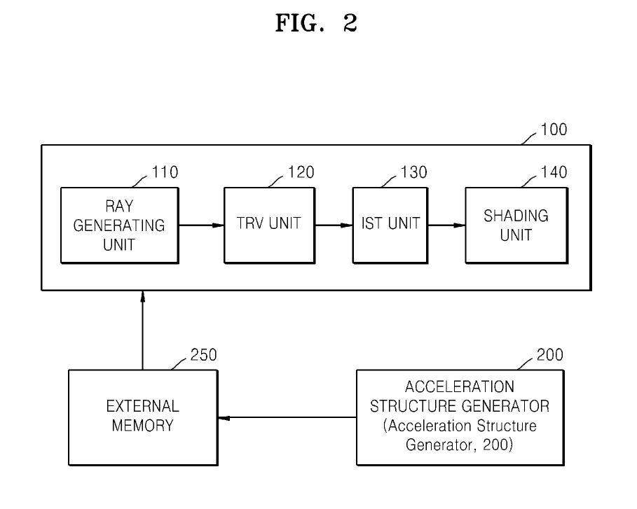

When the viewpoint 10 and the screen 15 are determined, a ray tracing apparatus 100 (see FIG. 2) may generate a ray for each pixel of the screen 15 from the viewpoint 10.

For example, as illustrated in FIG. 1, when the screen 15 has a resolution of about 4×3, the ray tracing apparatus 100 may generate a ray for each of the 12 pixels. Hereinafter, for convenience of explanation, only a ray for one pixel (e.g., pixel A) will be described.

Referring to FIG. 1, a primary ray 40 is generated for the pixel A from the viewpoint 10. The primary ray 40 passes a 3D space and reaches the first object 31. The first object 31 may include a set of unit regions (hereinafter, referred to as primitives). The primitive may have, for example, the shape of a polygon such as a triangle or a tetragon. In the following description, for convenience of explanation, it is assumed that the primitive has the shape of a triangle.

A shadow ray 50, a reflected ray 60, and a refracted ray 70 may be generated at a hit point between the primary ray 40 and the first object 31. The shadow ray 50, the reflected ray 60, and the refracted ray 70 are referred to as secondary rays.

The shadow ray 50 is generated from the hit point toward the light source 80. The reflected ray 60 is generated in a direction corresponding to an incidence angle of the primary ray 40, and is given a weight corresponding to the reflectivity of the first object 31. The refracted ray 70 is generated in a direction corresponding to the incidence angle of the primary ray 40 and the refractivity of the first object 31, and is given a weight corresponding to the refractivity of the first object 31.

The ray tracing apparatus 100 determines whether the hit point is exposed to the light source 80 through the shadow ray 50. For example, as illustrated in FIG. 1, when the shadow ray 50 meets the second object 32, a shadow may be generated at the hit point where the shadow ray 50 is generated.

Also, the ray tracing apparatus 100 determines whether the refracted ray 70 and the reflected ray 60 reach other objects. For example, as illustrated in FIG. 1, no object exists in a traveling direction of the refracted ray 70, and the reflected ray 60 reaches the third object 33. Accordingly, the ray tracing apparatus 100 detects coordinate and color information of a hit point of the third object 33, and generates a shadow ray 90 from the hit point of the third object 33. The ray tracing apparatus 100 also determines whether the shadow ray 90 is exposed to the light source 80.

Since the reflectivity and refractivity of the third object 33 is 0, a reflected ray and a refracted ray are not generated from the third object 33.

As described above, the ray tracing apparatus 100 analyzes the primary ray 40 for the pixel A and all rays derived from the primary ray 40, and determines a color value of the pixel A based on a result of the analysis. The determination of the color value of the pixel A depends on the color of a hit point of the primary ray 40, the color of a hit point of the reflected ray 60, and whether the shadow ray 50 reaches the light source 80.

The ray tracing apparatus 100 may construct the screen 15 by performing the above process on all pixels of the screen 15.

FIG. 2 is a diagram illustrating an example of a ray tracing system. Referring to FIG. 2, the ray tracing system may include a ray tracing apparatus 100, an external memory 250, and an acceleration structure (AS) generator 200. The ray tracing apparatus 100 may include a ray generating unit 110, a traversal (TRV) unit 120, an intersection test (IST) unit 130, and a shading unit 140.

The ray generating unit 110 may generate a primary ray and rays that are derived from the primary ray. As described with reference to FIG. 1, the ray generating unit 110 may generate a primary ray from the viewpoint 10, and may generate a secondary ray at a hit point between the primary ray and an object. The secondary ray may be a reflected ray, a refracted ray, or a shadow ray that is generated at the hit point between the primary ray and the object.

The ray generating unit 110 may generate a tertiary ray at a hit point between the secondary ray and an object. The ray generating unit 110 may continuously generate a ray until a ray does not hit an object, or the rays have been generated a predetermined number of times.

The TRV unit 120 may receive information about rays generated from the ray generating unit 110. The generated rays may include the primary ray and all rays (i.e., the secondary ray and the tertiary ray) derived from the primary ray. For example, the TRV unit 120 may receive information about the viewpoint and direction of the primary ray. Also, the TRV unit 120 may receive information about the start point and direction of the secondary ray. The start point of the secondary ray refers to the hit point between the primary ray and the object. Also, the viewpoint or the start point may be represented by coordinates and the direction may be represented by a vector.

The TRV unit 120 may read information about an acceleration structure (AS) from the external memory 250. The acceleration structure is generated by the acceleration structure generator 200, and the generated acceleration structure is stored in the external memory 250.

The acceleration structure generator 200 may generate an acceleration structure containing location information of objects on a 3D space. The acceleration structure generator 200 may divide the 3D space in the form of a hierarchical tree. The acceleration structure generator 200 may generate acceleration structures in various shapes. For example, the acceleration structure generator 200 may generate an acceleration structure representing the relation between objects in the 3D space by using K-dimensional tree (KD-tree), bounding volume hierarchy (BVH) method, spatial splits-in-BVH (SBVH), occlusion surface area heuristic (OSAH), and/or ambient occlusion BVH (AOBVH).

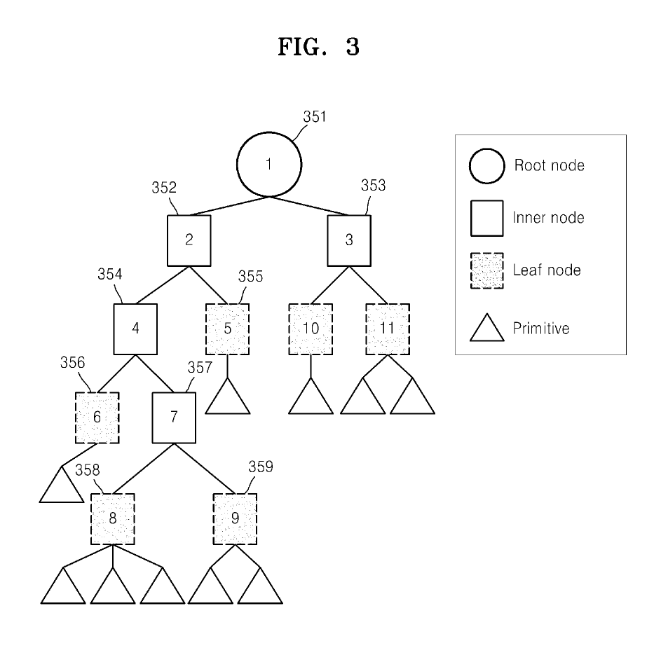

FIG. 3 is a diagram illustrating an example of an acceleration structure (AS) in the ray tracing system. For convenience of description, each node in the acceleration structure will be denoted by a numeral assigned to the node. For example, a node that is assigned a numeral “1” and is has a shape of a circle may be referred to as a first node 351, a node that is assigned a numeral “2” and has a shape of a tetragon may be referred to as a second node 352, and a node that is assigned a numeral “5” and has a shape of a tetragon with a dashed line may be referred to as a fifth node 355. The acceleration structure (AS) may include a root node, an inner node, a leaf node, and a primitive.

In FIG. 3, the first node 351 is a root node. The root node is an uppermost node that only has child nodes but does not have a parent node. For example, the child nodes of the first node 351 are the second node 352 and a third node 353, and the first node 351 does not have a parent node.

The second node 352 may be an inner node. The inner node is a node that has both a parent node and child nodes. For example, the parent node of the second node 352 is the first node 351, and the child nodes of the second node 352 are a fourth node 354 and the fifth node 355.

An eighth node 358 may be a leaf node. The leaf node is a lowermost node that has a parent node, but no child nodes. For example, the parent node of the eighth node 358 is the seventh node 357, and the eighth node 358 does not have child nodes. The leaf node may include primitives that exist in a leaf node. For example, as illustrated in FIG. 3, a sixth node 356, which is a leaf node, includes one primitive. The eighth node 358, which is a leaf node, includes three primitives. A ninth node 359, which is a leaf node, includes two primitives.

Referring to FIG. 2, the TRV unit 120 may detect a leaf node hit by a ray, by searching for the information about the acceleration structure read from the external memory 250. The IST unit 130 may receive information regarding the detected leaf node hit by a ray from the TRV unit 120. The IST unit 130 may read information (geometry data) about the primitives included in the received leaf node from the external memory 250. The IST unit 130 may perform an intersection test between the ray and the primitives by using the information about the primitives, which is read from the external memory 250. For example, the IST unit 130 may check which of the primitives included in the leaf node received from the TRV unit 120 has been hit by the ray. Accordingly, the ray tracing apparatus 100 may detect the primitives hit by the ray and calculate the hit point between the detected primitive and the ray. The calculated hit point may be output in the form of coordinates to the shading unit 140.

The shading unit 140 may determine a color value of the pixel based on information about the hit point and the physical properties of a material of the hit point. The shading unit 140 may determine a color value of the pixel in consideration of the basic color of the material of the hit point and the effect of a light source. For example, the shading unit 140 may determine a color value of the pixel A in consideration of all the effects of the primary ray 40 and the secondary rays, i.e., the refracted ray 70, the reflected ray 60, and the shadow ray 60.

The ray tracing apparatus 100 may receive data necessary for ray tracing from the external memory 250. The external memory 250 may store the acceleration structure or the geometry data.

The acceleration structure is generated by the acceleration structure generator 200, and the generated acceleration structure is stored in the external memory 250.

The geometry data represents information about primitives. The primitive may have the shape of a polygon such as, for example, a triangle or a tetragon. The geometry data may represent information about the vertexes and locations of primitives included in the object. For example, when the primitive has the shape of a triangle, the geometry data may include vertex coordinates of three points of a triangle, a normal vector, or texture coordinates.

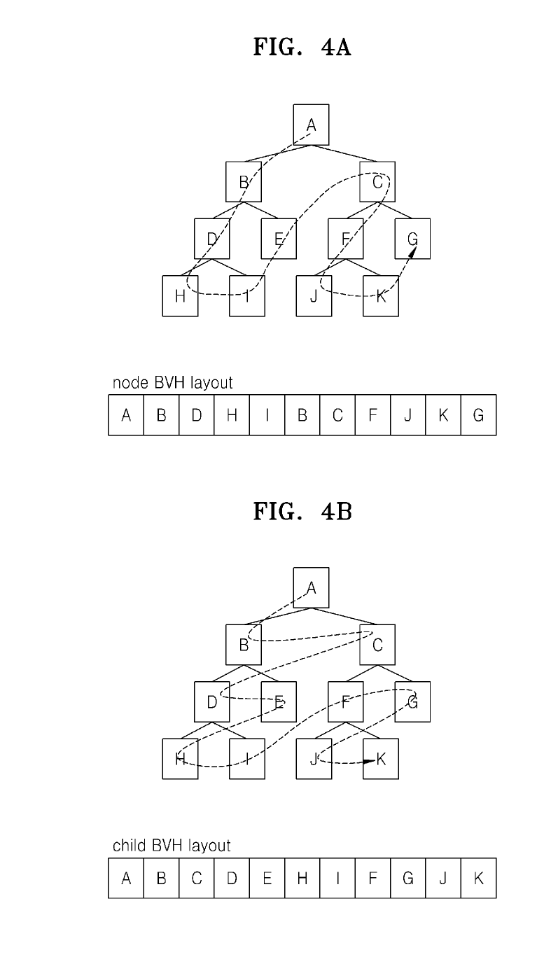

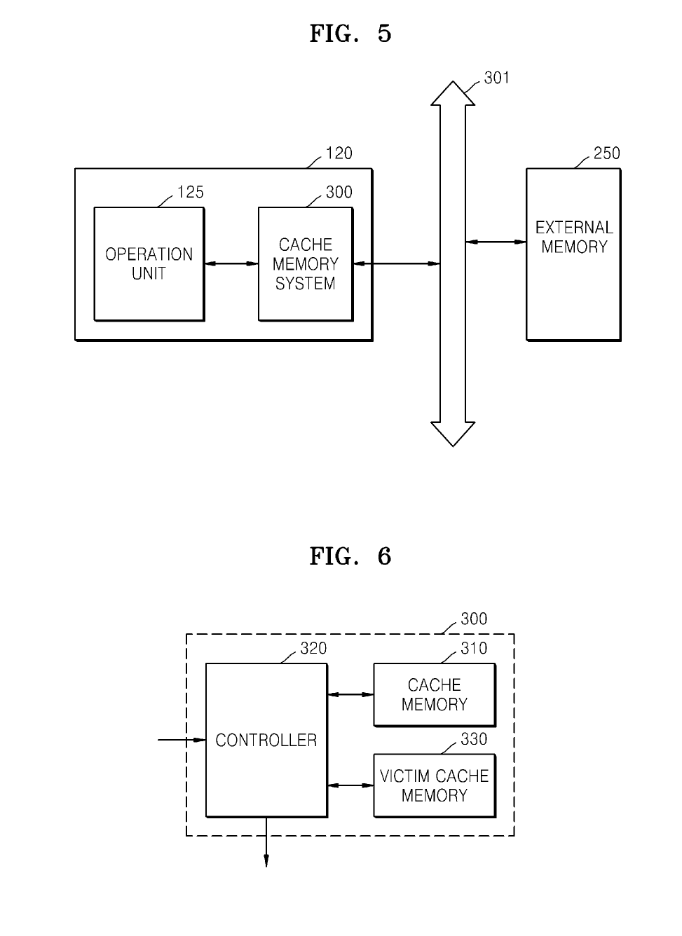

FIGS. 4A and 4B are diagrams illustrating examples of an acceleration structure traversal method. FIG. 4 is a diagram illustrating a node BVH traversal method that is a depth-first traversal method. FIG. 4B is a diagram illustrating a child BVH traversal method.

Referring to FIG. 4A, in the node BVH traversal method, an intersection test may be performed on a first node A. The information about a third node C that is a right child node of the first node A may be stored in a stack and an intersection test may be performed on a second node B that is a left child node of the first node A. Information about a fifth node E that is a right child node of the second node B may be stored in the stack, and an intersection test may be performed on a fourth node D that is a left child node of the second node B. In this manner, after an intersection test is performed on up to a leaf node H, the node stored in the stack is popped to move to a relevant node and an intersection test may be continuously performed on the relevant node.

When the traversal is performed in this manner, node data necessary for the traversal of the acceleration structure may be stored in the external memory 250. The node data necessary for the traversal may be arranged in the order of first node A data, second node B data, fourth node D data, and eighth node H data, as illustrated in FIG. 4A.

Referring to FIG. 4B, in the child BVH traversal method, an intersection test may be performed on the first node A, and then an intersection test may be performed on both child nodes of the first node A, the second node B and the third node C. When both the second node B and the third node C are hit by a ray as a result of the intersection test, information about the third node C that is a right child node may be stored in the stack. An intersection test may be performed on the fourth node D and the fifth node E that are child nodes of the second node B. When both the fourth node D and the fifth node E are hit by a ray as a result of the intersection test, information about the fifth node E that is a right child node may stored in the stack. An intersection test may be performed until the leaf node H and the leaf node I are traversed. When the leaf nodes are traversed, the node stored in the stack may be popped to move to a relevant node and an intersection test may be continuously performed on the relevant node.

When the traversal is performed in this manner, node data necessary for the traversal of the acceleration structure may be stored in the external memory 250. The node data necessary for the traversal may be arranged in the order of first node A data, second node B data, third node C data, and fourth node D data, as illustrated in FIG. 4B.

Since node information is not stored in the stack when only one side child node is hit, compared to the node BVH traversal method illustrated in FIG. 4A, the child BVH traversal method may reduce a stack operation.

FIG. 5 is a diagram illustrating an example of a TRV unit 120. Referring to FIG. 5, the TRV unit 120 may include an operation unit 125 and a cache memory system 300. As described with reference to FIG. 4, in order to request node data, which is information about a node necessary for acceleration structure traversal, the TRV unit 120 accesses a cache memory before accessing the external memory 250. The TRV unit 120 applies a node data request to the cache memory system 300.

When the requested node data exists in a cache memory 310 (see FIG. 6), a cache hit operation is performed and cache data (node data) output from the cache memory 310 is applied to the operation unit 125.

Node data of the external memory 250, which is frequently used, may have a high probability of being stored in the cache memory 310. Thus, the TRV unit 120 may access the cache memory 310 before the external memory 250, thereby improving a data transfer rate.

On the other hand, when the requested node data does not exist in the cache memory 310, to a cache miss operation is performed. Accordingly, the external memory 250 is accessed, and data output from the external memory 250 is applied to the cache memory system 300 through a system bus 301.

An operation of the cache memory system 300 will be described below in detail with reference to FIGS. 6 to 12.

FIG. 6 is a diagram illustrating an example of the cache memory system 300 of FIG. 5. Referring to FIG. 6, the cache memory system 300 may include the cache memory 310, a controller 320, and a victim cache memory 330.

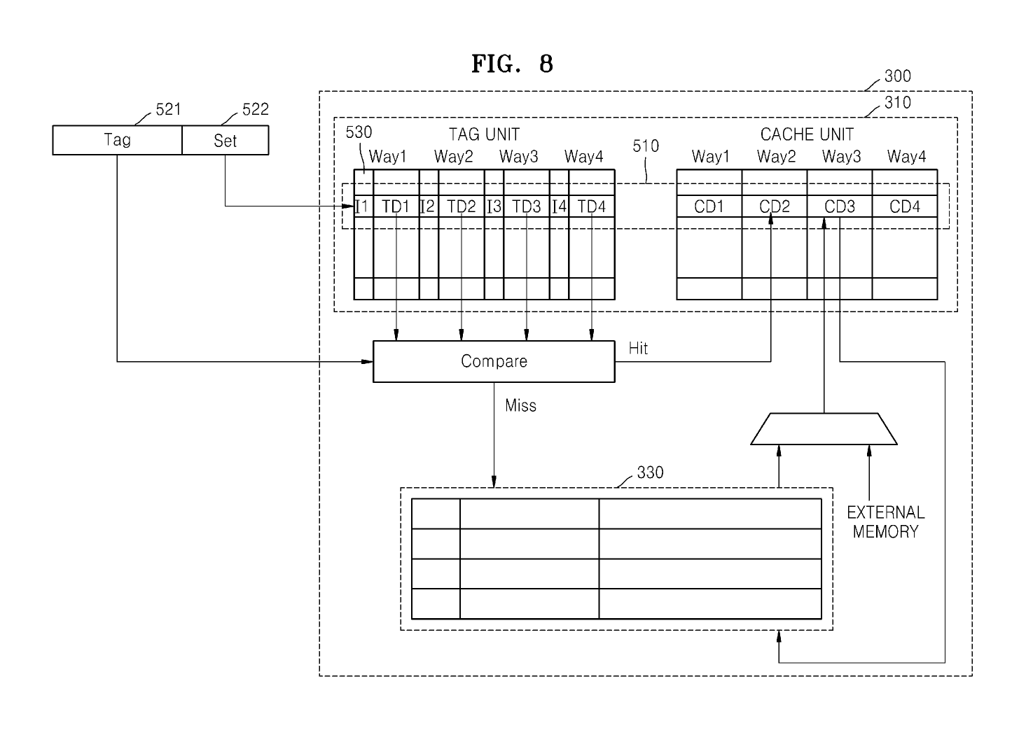

The cache memory 310 may store a portion of node data stored in the external memory 250 as cache data and it may store hit frequency data corresponding to the cache data and tag data representing addresses of the cache data. The cache data is equal to any one of the node data stored in the external memory 250, and the tag data represents actual addresses of the external memory 250 where the cache data is stored. The hit frequency data may be determined based on an access reservation frequency to a relevant node. An example of a structure of the cache memory 310 will be described with reference to FIG. 8.

Referring to FIG. 8, the cache memory 310 includes a plurality of data sets. Herein, one data set 510 includes a plurality of pieces of tag data, a plurality of pieces of cache data, and a plurality of pieces of hit frequency data. For example, when the cache memory 310 includes a 4-way set associative cache memory, one data set 510 may include first to fourth cache data CD1, CD2, CD3, and CD4 and first to fourth tag data TD1, TD2, TD3, and TD4 that represent addresses of the first to fourth cache data CD1, CD2, CD3, and CD4, respectively. Also, the data set may include first to fourth hit frequency data I1, I2, I3, and I4 that represent the hit frequencies of the first to fourth cache data CD1, CD2, CD3, and CD4, respectively.

The cache memory 310 may include a cache unit storing cache data, a tag unit storing tag data, and an I-region 530 storing hit frequency data. In a non-exhaustive example, the I-region 530 may be included in the tag unit. The cache memory system 300 may increase the hit frequency data of a relevant node stored in the stack, when storing one side child node in the stack, while performing acceleration structure traversal, because both side child nodes are hit, as described with reference to FIG. 4B. When popping to the node stored in the stack, the cache memory system 300 may reduce the hit frequency data of the relevant node. For example, as illustrated in FIG. 4B, the cache memory system 300 may perform an intersection test on the child nodes (the second node B and the third node C) of the first node A and store the third node C in the stack when both the second node B and the third node C are hit by a ray. The cache memory system 300 may increase the hit frequency data corresponding to third node C data by 1. When popping and moving to the third node C and outputting third node C data from the cache memory 310, the cache memory system 300 may reduce the hit frequency data corresponding to the third node C data by 1.

When there is a request for any node data, the controller 320 determines whether the node data corresponding to the request is stored in the cache memory 310, i.e., whether a cache hit or a cache miss occurs. Depending on a determination result, based on the hit frequency data, the controller 320 may delete any one of the cache data included in the data set and update the same into new data.

The cache memory system 300 may further include the victim cache memory 330. The victim cache memory 330 may temporarily store the cache data deleted from the cache memory 310.

Based on the hit frequency data corresponding to the cache data deleted from the cache memory 310, the controller 320 may determine whether to store the deleted cache data in the victim cache memory 330. When the deleted cache data is stored in the victim cache memory 330 and there is a request for the deleted cache data, the controller 320 acquires node data by accessing the victim cache memory 330 without accessing the external memory 250, thereby increasing the data processing speed.

Accordingly, when the requested node data is not stored in the cache memory 310, the controller 320 determines whether the requested node data is stored in the victim cache memory 330. When the requested node data is stored in the victim cache memory 330, the controller 320 may read the relevant node data.

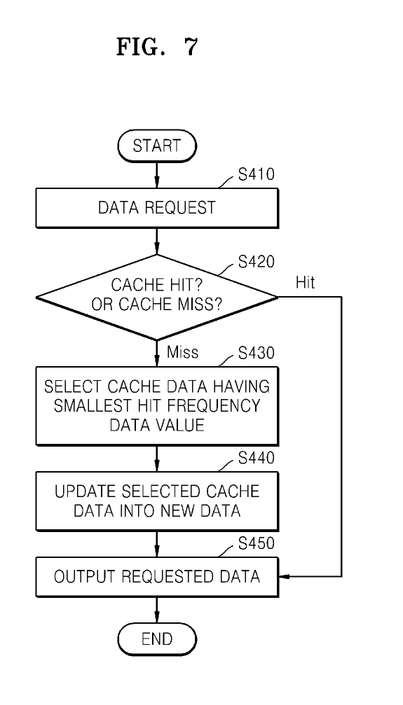

FIG. 7 is a diagram illustrating an example of a method of operating a cache memory system. The operations in FIG. 7 may be performed in the sequence and manner as shown, although the order of some operations may be changed or some of the operations omitted without departing from the spirit and scope of the illustrative examples described. Many of the operations shown in FIG. 7 may be performed in parallel or concurrently. The above descriptions of FIGS. 1-6, is also applicable to FIG. 7, and is incorporated herein by reference. Thus, the above description may not be repeated here. FIG. 8 is a diagram illustrating an example of the operating method of FIG. 7.

Referring to FIG. 7, in S410, the cache memory system 300 may receive a node data request from the operation unit 125. Herein, the node data may be data about node information that is needed for a ray-node intersection test described with reference to FIG. 2. For example, the node data may include the coordinate values of vertexes constituting the node, the maximum coordinate value of the node, the minimum coordinate value of the node, parent node information, and child node information. In response to the node data request, the cache memory system 300 may receive a tag address 521 and a set address 522 of the node data, as illustrated in FIG. 8.

In S420, the cache memory system 300 determines whether the requested node data is stored in the cache memory 310, i.e, whether a cache hit or a cache miss occurs. As illustrated in FIG. 8, the controller 320 may compare the first, second, third, and fourth tag data TD1, TD2, TD3, and TD4 included in the data set 510 indicated by the received set address 522 with the tag address 521 to determine whether the cache data corresponding to the request is stored. When any one of the first to fourth tag data TD1, TD2, TD3, and TD4 match the tag address 521, the cache memory system 300 determines that a cache hit occurs. When none of the first to fourth tag data TD1, TD2, TD3, and TD4 match the tag address 521, the cache memory system 300 determines that a cache miss occurs.

In S450, in the event of a cache hit, the cache memory system 300 outputs the cache data corresponding to the matching tag data. For example, when the tag address 521 and the second tag data TD2 match each other, the cache memory system 300 may output the second cache data CD2 corresponding to the second tag data TD2.

In S430, in the event of a cache miss, the cache memory system 300 compares a plurality of pieces of hit frequency data included in the data set 510 indicated by the received set address 522, selects the cache data having the smallest value. In S440, the cache memory system 300 deletes the selected cache data, and updates the same into new data. For example, as illustrated in FIG. 8, the cache memory system 300 may compare the first to fourth hit frequency data I1, I2, I3, and I4 corresponding to the first to fourth cache data CD1, CD2, CD3, and CD4, respectively, included in the data set 510 indicated by the set address 522, and select the hit frequency data having the smallest value. In this case, when the third hit frequency data I3 has the smallest value, the cache memory system 300 may delete the third cache data CD3 corresponding to the third hit frequency data I3 and update the same into new data.

The cache memory system 300 may determine whether the requested node data is stored in the victim cache memory 330 and update the relevant node data into new data when the requested node data is stored in the victim cache memory 330. The cache memory system 300 may also update data received from an external memory region indicated by the tag address 521 into new data.

The cache memory system 300 updates the third tag data TD3 and the third hit frequency data I3 corresponding to the updated third cache data CD3 into new data. The cache memory system 300 may store the deleted cache data in the victim cache memory 330. In S450, the cache memory system 300 outputs the new data.

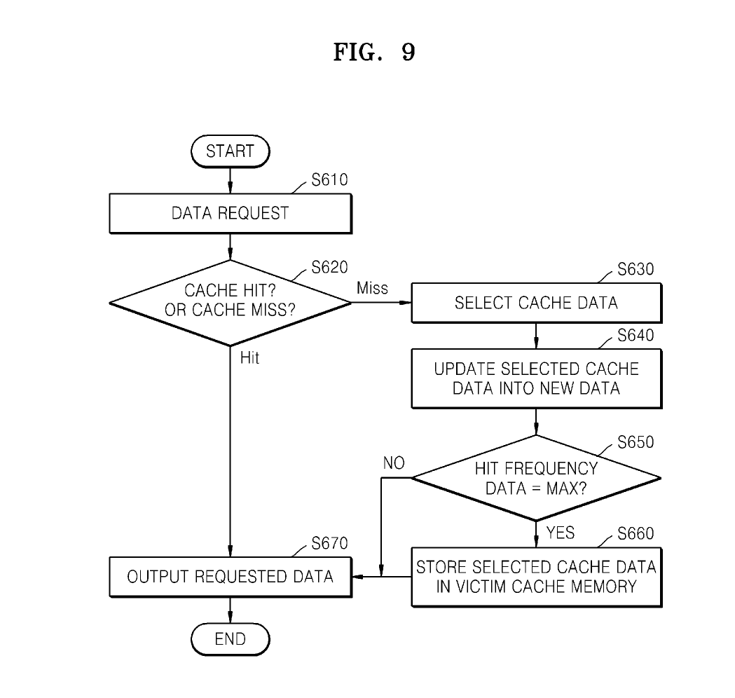

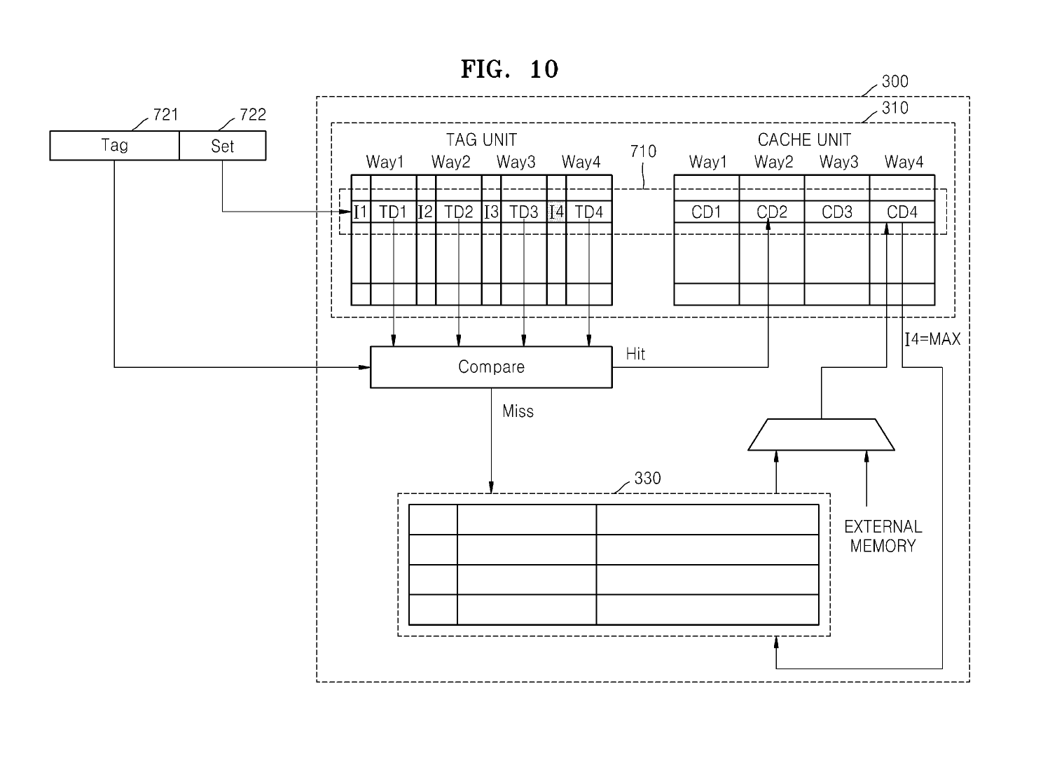

FIG. 9 is a diagram illustrating an example of a method of operating a cache memory system. The operations in FIG. 9 may be performed in the sequence and manner as shown, although the order of some operations may be changed or some of the operations omitted without departing from the spirit and scope of the illustrative examples described. Many of the operations shown in FIG. 9 may be performed in parallel or concurrently. The above descriptions of FIGS. 1-8, is also applicable to FIG. 9, and is incorporated herein by reference. Thus, the above description may not be repeated here. FIG. 10 is a diagram illustrating an example of the operating method of FIG. 9.

In S610, the cache memory system 300 receives a node data request from the operation unit 125, and In S620, the cache memory system 300 determines whether the requested node data is stored in the cache memory, i.e., whether a cache hit or a cache miss occurs. Operations S610 and S620 of FIG. 9 correspond respectively to operations S410 and S420 of FIG. 7. The above descriptions of operations S410 and S420 of FIG. 7 are incorporated herein by reference, and may not be repeated here.

In S670, in the event of a cache hit, the cache memory system 300 outputs the requested node data. Operation S670 of FIG. 9 corresponds to operation S450 of FIG. 7. The above descriptions of operations S450 of FIG. 7 is incorporated herein by reference, and may not be repeated here.

In S630, in the event of a cache miss, the cache memory system 300 may select any one of a plurality of pieces of cache data, namely, first to fourth cache data CD1, CD2, CD3, and CD4, included in a data set 710 indicated by a received set address 722. In an example, the deleted cache data from among the plurality of pieces of cache data included in the data set 710 may be selected based on a predetermined criterion. For example, the deleted cache data may be selected by a least recently used (LRU) method, a most recently used (MRU) method, a first in first out (FIFO) method, or last in first out (LIFO) method.

In S640, the cache memory system 300 updates the selected cache data into new data. Operation S640 of FIG. 9 corresponds to operation S440 of FIG. 7. The above descriptions of operations S440 of FIG. 7 is incorporated herein by reference, and may not be repeated here.

The cache memory system 300 may determine whether to store the deleted cache data in the victim cache memory, based on the hit frequency data of the deleted cache data. For example, in S650, the cache memory system 300 may determine whether the hit frequency data of the deleted cache data has a maximum value in the data set. In S660, cache memory system 300 may store the deleted cache data in the victim cache memory when the hit frequency data of the deleted cache data has the maximum value.

As illustrated in FIG. 10, when the fourth cache data CD4 is selected as the deleted cache data and fourth hit frequency data I4 of the fourth cache data CD4 has a maximum value among the hit frequency data corresponding to the cache data included in the same data set 710, the cache memory system 300 may store the fourth cache data CD4 in the victim cache memory 330. In this case, the cache memory system 300 may also store the fourth tag data TD4 and the fourth hit frequency data I4 corresponding to the fourth cache data CD4 in the victim cache memory 330.

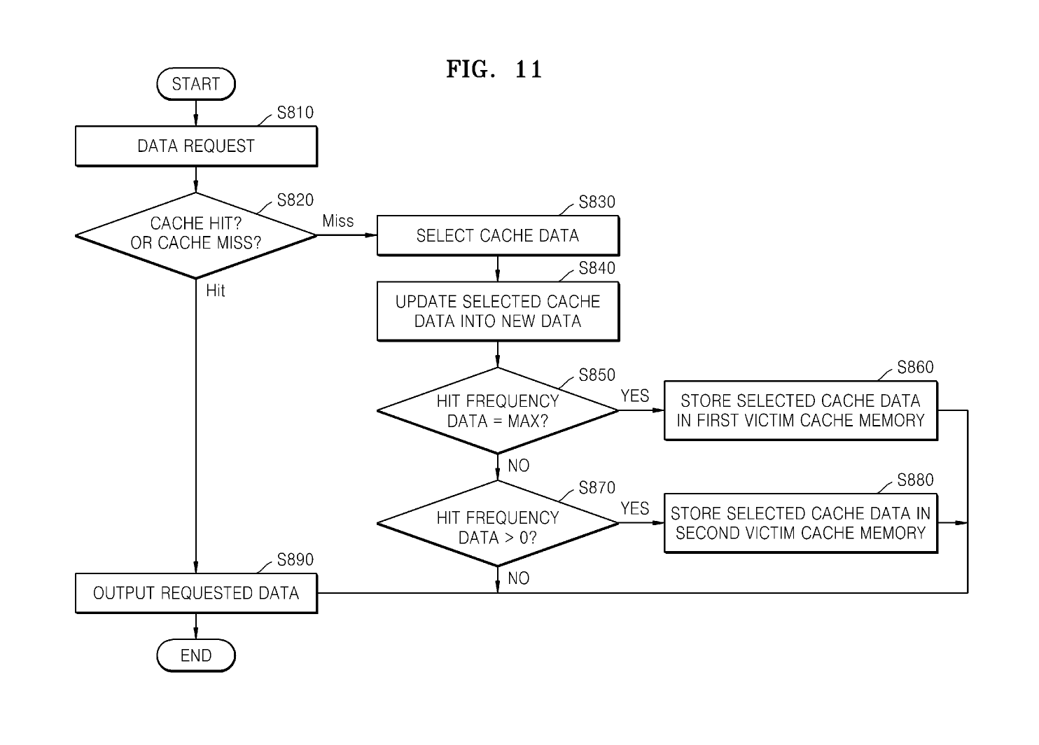

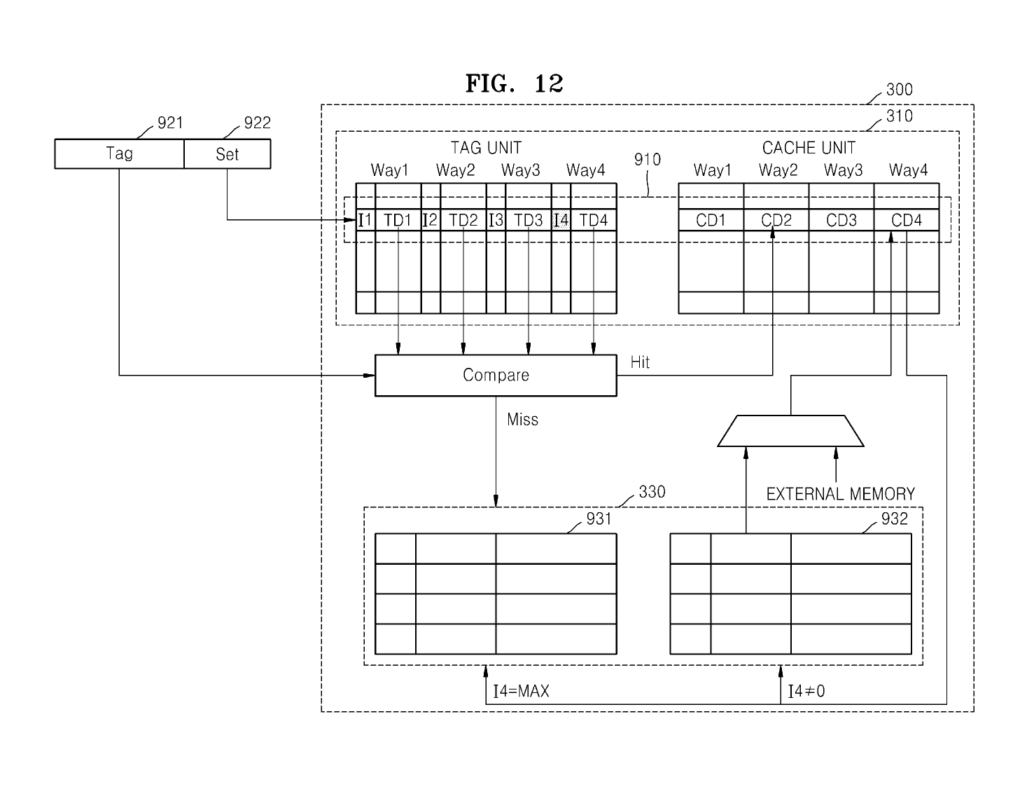

FIG. 11 is a diagram illustrating an example of a method of operating a cache memory system. The operations in FIG. 11 may be performed in the sequence and manner as shown, although the order of some operations may be changed or some of the operations omitted without departing from the spirit and scope of the illustrative examples described. Many of the operations shown in FIG. 11 may be performed in parallel or concurrently. The above descriptions of FIGS. 1-10, is also applicable to FIG. 11, and is incorporated herein by reference. Thus, the above description may not be repeated here. FIG. 12 is a diagram illustrating an example of the operating method of FIG. 11.

Referring to FIG. 11, in S810, the cache memory system 300 receives a node data request from the operation unit 125 of the TRV unit 120. In S820, the cache memory system 300 determines whether the requested node data is stored in the cache memory 310, i.e, whether a cache hit or a cache miss occurs. Operations S810 and S820 of FIG. 11 correspond to operations S410 and S420 of FIG. 7, respectively. The above descriptions of operations S410 and S420 of FIG. 7 is incorporated herein by reference, and may not be repeated here.

In the event of a cache hit, in S890, the cache memory system 300 outputs the requested node data. Operation S890 of FIG. 11 corresponds to operation S450 of FIG. 7. The above descriptions of operations S450 of FIG. 7 is incorporated herein by reference, and may not be repeated here.

In the event of a cache miss, in S830, the cache memory system 300 may select any one of a plurality of pieces of cache data, namely, first to fourth cache data CD1, CD2, CD3, and CD4, included in a data set 910 indicated by a received set address 922. Operation S830 of FIG. 11 corresponds to operation S630 of FIG. 9. The above descriptions of operations S630 of FIG. 9 is incorporated herein by reference, and may not be repeated here.

In S840, the cache memory system 300 updates the selected cache data into new data. Operation S840 of FIG. 11 corresponds to operation S440 of FIG. 7. The above descriptions of operations S440 of FIG. 7 is incorporated herein by reference, and may not be repeated here.

The cache memory system 300 may determine whether to store the deleted cache data in a first victim cache memory 931 or a second victim cache memory 932, based on the hit frequency data of the deleted cache data. For example, in S850, the cache memory system 300 may determine whether the hit frequency data of the deleted cache data has a maximum value in the data set 910. In S860, the cache memory system 300 may store the deleted cache data in the first victim cache memory 931 when the hit frequency data of the deleted cache data has the maximum value.

As illustrated in FIG. 12, when the fourth cache data CD4 is selected as the deleted cache data and fourth hit frequency data I4 of the fourth cache data CD4 has a maximum value among the hit frequency data corresponding to the cache data included in the same data set 910, the cache memory system 300 may store the fourth cache data CD4 in the first victim cache memory 931. The cache memory system 300 may also store fourth tag data TD4 and the fourth hit frequency data I4 corresponding to the fourth cache data CD4 in the first victim cache memory 931.

In S870, when the hit frequency data of the deleted cache data has a value greater than 0 and does not have a maximum value in the data set, in S880, the cache memory system 300 may store the deleted cache data in the second victim cache memory 932.

As illustrated in FIG. 12, when the fourth cache data CD4 is selected as the deleted cache data and the fourth hit frequency data I4 of the fourth cache data CD4 has a value greater than 0 and does not have a maximum value among the hit frequency data corresponding to the cache data included in the same data set 910, the cache memory system 300 may store the fourth cache data CD4 in the second victim cache memory 932. The cache memory system 300 may also store the fourth tag data TD4 and the fourth hit frequency data I4 corresponding to the fourth cache data CD4 in the second victim cache memory 932.

As described above, since the node data may be efficiently stored in the cache memory, the probability of a cache miss may be reduced in acceleration structure traversal.

Accordingly, the acceleration structure traversal may be performed more rapidly, and the processing power and processing speed of the ray tracing apparatus may be improved.

The cache memory systems, processes, functions, and methods described above can be written as a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device that is capable of providing instructions or data to or being interpreted by the processing device. The software also may be distributed over network coupled computer systems so that the software is stored and executed in a distributed fashion. In particular, the software and data may be stored by one or more non-transitory computer readable recording mediums. The non-transitory computer readable recording medium may include any data storage device that can store data that can be thereafter read by a computer system or processing device. Examples of the non-transitory computer readable recording medium include read-only memory (ROM), random-access memory (RAM), Compact Disc Read-only Memory (CD-ROMs), magnetic tapes, USBs, floppy disks, hard disks, optical recording media (e.g., CD-ROMs, or DVDs), and PC interfaces (e.g., PCI, PCI-express, WiFi, etc.). In addition, functional programs, codes, and code segments for accomplishing the example disclosed herein can be construed by programmers skilled in the art based on the flow diagrams and block diagrams of the figures and their corresponding descriptions as provided herein.

The apparatuses and units described herein may be implemented using hardware components. The hardware components may include, for example, controllers, sensors, processors, generators, drivers, and other equivalent electronic components. The hardware components may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The hardware components may run an operating system (OS) and one or more software applications that run on the OS. The hardware components also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a hardware component may include multiple processors or a processor and a controller. In addition, different processing configurations are possible, such a parallel processors.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A cache memory apparatus comprising:
a cache memory configured to store node data of an acceleration structure as cache data and to store hit frequency data corresponding to the cache data; and
a controller configured to determine whether node data corresponding to a request is stored in the cache memory, and to update any one of the cache data based on the hit frequency data.

2. The cache memory apparatus of claim 1, wherein the hit frequency data is determined based on an access reservation frequency to a relevant node.

3. The cache memory apparatus of claim 1, wherein the node data is information about a node for traversing the acceleration structure in ray tracing.

4. The cache memory apparatus of claim 1, wherein
the cache memory comprises a plurality of data sets, and each of which comprises the cache data, the hit frequency data, and tag data.

5. The cache memory apparatus of claim 4, wherein the controller is further configured:
to receive a set address and a tag address of the requested node data, and
to compare the tag data denoted by the set address with the tag address to determine whether the requested node data is stored.

6. The cache memory apparatus of claim 5, wherein the controller is further configured to determine that a cache hit occurs and to output the corresponding cache data, in response to the determination that the tag address matches any one of the tag data.

7. The cache memory apparatus of claim 5, wherein the controller is further configured to delete the cache data corresponding to a hit frequency data having a smallest value from among the hit frequency data, in response to the tag address not matching any one of the tag data.

8. The cache memory apparatus of claim 5, wherein the controller is further configured to determine that a cache miss occurs and to receive new data from a region of an external memory that is indicated by the tag address, in response to the tag address not matching any one of the tag data.

9. The cache memory apparatus of claim 1, wherein the controller is further configured to increase a value of the hit frequency data corresponding to the node data in response to a node being pushed into a stack.

10. The cache memory apparatus of claim 1, further comprising a victim cache memory configured to store the cache data deleted from the cache memory.

11. The cache memory apparatus of claim 10, wherein the controller is further configured to determine that a cache miss occurs and to search whether the node data corresponding to the request is stored in the victim cache memory, in response to the node data corresponding to the request not being stored in the cache memory.

12. A method of managing cache memory, the method comprising:
receiving a request for at least one node data of an acceleration structure;
determining whether the requested node data is stored in the cache memory;
selecting a cache data stored in the cache memory based on hit frequency; and
updating the selected cache data.

13. The method of claim 12, wherein the hit frequency data is determined based on an access reservation frequency to a relevant node.

14. The method of claim 12, wherein
the receiving of the request comprises receiving a set address and a tag address of the requested node data, and
the determining of whether the requested node data is stored in the cache memory comprises comparing a tag data indicated by the set address with the tag address to determine whether the requested node data is stored, wherein the cache memory comprises a plurality of cache data, hot frequency data, and tag data.

15. The method of claim 14, further comprising determining that a cache hit occurs and outputting the cache data corresponding to the matching tag data, in response to any one of the tag data matching the tag address.

16. The method of claim 14, wherein the selecting of the cache data comprises determining that a cache miss occurs and selecting the cache data corresponding to the hit frequency data having a smallest value from among the hit frequency data indicated by the set address, in response to the tag address not matching any one of the tag data.

17. The method of claim 14, further comprising determining that a cache miss occurs and receiving new data from a region of an external memory that is indicated by the tag address, in response to the tag address not matching any one of the tag data.

18. The method of claim 12, further comprising increasing a value of the hit frequency data corresponding to the node data in response to a node being pushed into a stack.

19. The method of claim 12, further comprising storing the cache data deleted from the cache memory in a victim cache memory.

20. The method of claim 12, further comprising, determining that a cache miss occurs and searching whether the node data corresponding to the request is stored in the victim cache memory, in response to the node data corresponding to the request not being stored in the cache memory.
